(19) United States
(12) Patent Application Publication
(10) Pub. No.: US 2023/0183539 A1
(43) Pub. Date: Jun. 15, 2023

(54) A COMPOSITE PHASE CHANGE MATERIAL AND ITS METHOD OF PREPARATION THEREOF

(71) Applicant: JAIN, Samit, Gurgaon (IN)

(72) Inventors: Anil MEHTA KUMAR, Gurgaon (IN); Akshat RASTOGI, Gurgaon (IN); Tanya AGRAWAL, Gurgaon (IN); Manikantan KOTA, Gurgaon (IN); Nidhi AGRAWAL, Gurgaon (IN)

(21) Appl. No.: 17/916,706

(22) PCT Filed: Jan. 22, 2021
(86) PCT No.: PCT/IN2021/050064

§ 371 Date: Oct. 3, 2022

(30) Foreign Application Priority Data
Jan. 22, 2020 (IN) 202011002902

(51) Int. Cl. C09K 5/06

(52) U.S. Cl. CPC C09K 5/06

(57) ABSTRACT

The present disclosure is a composite phase change material and its method of preparation thereof. The composite phase change material includes a phase change material present in an amount of 50%-80% by weight. The composite phase change material further includes a thermally conductive material present in an amount of 10%-30% by weight. The composite phase change material further includes a flame retardant present in an amount of 0%-10% by weight. The composite phase change material further includes a polymer present in an amount of 0%-15% by weight.

### TECHNICAL FIELD

The present invention generally relates to the field of phase change materials, and more particularly, the present invention relates to a composite phase change material for thermal management of a system, and a method of preparation of the composite phase change material.

### BACKGROUND ART

Thermal management of lithium ion cells is critical in high-power applications such as UPS, electric vehicle, solar power storage, electric wheelchair etc. During charging and discharging cycles, the lithium ion cells heats up, causing an increase in their temperature which eventually reduces the life and efficiency of the cells. One of the side effects of exposure to high temperature is premature aging and accelerated capacity-fade of the cells. Therefore, an efficient thermal management system that continuously regulates cell operating temperature is essential for safe and optimal performance in high temperature and high discharge lithium ion applications.

Majority of the conventional technologies use active cooling systems. The active cooling systems include several moving parts which increase the overall weight of the system, and also consume extra space within the system. A phase change material is an alternative to conventional technologies, especially because it is capable of removing large quantities of heat due to its high latent heat of fusion. The phase change material is suitable for passively maintaining the temperature of the system below the critical temperature. However, there are certain disadvantages associated with the use of existing phase change materials.

Therefore, in light of the discussion above, there is a need for a novel and improved composite phase change material that does not suffer from above mentioned limitations.

### OBJECT OF THE INVENTION

An object of the present invention is to provide a novel composite phase change material.

Another object of the present invention is to provide a method of preparing a novel composite phase change material.

### SUMMARY OF THE INVENTION

According to an exemplary embodiment of the present invention, a composite phase change material is disclosed. The composite phase change material includes a phase change material. The phase change material may be present in an amount of 50%-80% by weight. The composite phase change material further includes a thermally conductive material. The thermally conductive material may be present in an amount of 10%-30% by weight. The phase change material further includes a flame retardant. The flame retardant may be present in an amount of 0%-10% by weight. The composite phase change material further includes a polymer. The polymer may be present in an amount of 0%-15% by weight.

According to another exemplary embodiment of the present invention, a method of preparing a composite phase change material is disclosed. The method of preparing the composite phase change material includes a step of compressing a thermally conductive material to a predefined density. The method further includes a step of mixing or infiltrating the phase change material into the compressed thermally conductive material. The method further includes a step of coating a composite of phase change material absorbed thermally conductive material with a flame retardant slurry or resin.

According to yet another exemplary embodiment of the present invention, a method of preparing a composite phase change material is disclosed. The method of preparing the composite phase change material includes a step of mixing a phase change material with a thermally conductive material. The method further includes a step of compressing the mixture of thermal conductivity material and the phase change material. The method further includes a step of coating the compressed mixture of the thermally conductive material and the phase change material with a flame retardant slurry or resin.

It is to be understood that both the foregoing general description and the following detailed description are exemplary and explanatory only and are not restrictive of the invention, as claimed.

### BRIEF DESCRIPTION OF THE ACCOMPANYING DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following figures, with like reference numbers referring to like structures across the views, wherein:

FIG. 1 illustrates a schematic diagram of a method of preparing a composite phase change material, in accordance with an exemplary embodiment of the present invention;

FIG. 2 illustrates a schematic diagram of a method of preparing a composite phase change material, in accordance with another exemplary embodiment of the present invention;

FIG. 3 illustrates the compressed thermally conductive material with varied initial compression densities from 0.2 to 0.5 g/cc, in accordance with an exemplary embodiment of the present invention;

FIG. 4 illustrates a graph representing product density v/s % of phase change material (PCM) absorption for PCMs having melting temperature of 42° C. and 48° C., in accordance with an exemplary embodiment of the present invention;

FIG. 5 illustrates a graph representing variation in density of thermally conductive material with change in PCM absorption percentage, in accordance with an exemplary embodiment of the invention; and

FIG. 6 illustrates a chart showing the properties of the composite phase change material based on various compositions, in accordance with an exemplary embodiment of the present invention.

### DETAILED DESCRIPTION OF THE PREFERRED EMBODIMENTS

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawings, wherein reference numerals used in the accompanying drawings correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art.

The invention will now be illustrated in detail. According to an exemplary embodiment of the present invention, a composite phase change material is disclosed in accordance with an exemplary embodiment of the invention. The composite phase change material (hereinafter referred to as composite) may be employed in heat generating systems in order to absorb the heat released from the system. In other words, the composite may be employed in heat generating systems to facilitate cooling of such systems. For example, the composite may be employed in electric cars having lithium ion cells to maintain the temperature of the cells. The lithium ion cells are known to generate heat, and therefore it is important to maintain their temperature below a specific temperature for sustaining their life. If the temperature is not maintained, the cells may cause thermal runaway which may eventually lead to an explosion or fire. Similarly, the composite may also be employed in solar photovoltaic system. The composite may be provided to control the temperature of the solar photovoltaic panels of the solar photovoltaic system. In a general scenario, the efficiency of the solar photovoltaic system reduces when the temperature of the system exceeds 25° C. Therefore, the composite enables the solar photovoltaic system to passively cool down leading to increase in the efficiency.

According to an embodiment, the composite may be molded in the form of an enclosure for covering the cells. According to another embodiment, the composite may be molded in a shape such that it can be sandwiched between the cells. It will be apparent to a person skilled in the art that the composite may be molded in any shape depending on the application. It will be further apparent to a person skilled in the art that the implementation of the composite may not be limited to lithium ion cells of electric cars, and the composite may be implemented in any heat generating systems known in the art. For the purpose of explanation, when the composite is implemented with lithium ion cells, the composite may absorb the heat from the cells and undergo phase transformation. Subsequently, the composite may dissipate the heat into the atmosphere thereby maintaining the temperature of the cells within a safe level.

The composite may include a phase change material (PCM). The PCM may be added in the composite to enhance the thermal storage capacity of the composite. The PCM may be present in an amount of 50%-80% by weight of the total composite weight. In some embodiments, the composite may include a combination of a plurality of phase change materials having different melting temperatures. A person skilled in the art will appreciate that a combination of phase change materials having different melting temperatures may be used in order to maintain the cell temperature at different temperatures. According to an embodiment, the phase change material selected for the composite may have a phase change temperature in the range of 30° C. to 60° C. Further, the phase change materials may be selected from the group consisting of paraffin, fatty acids and blends of organic materials. In an embodiment, the PCM may be a paraffin. The paraffin may include, but may not be limited to, Eicosane, Henicosane, Tricosane, Tetracosane etc. In another embodiment, the PCM may be a fatty acid. The fatty acid may include, but may not be limited to, lauric acid, stearic acid, palmitic acid, etc. In yet another embodiment, the PCM may be a blend of organic materials. Moreover, in certain embodiments, the PCM may be a combination of at least two or more of the above materials.

The composite may further include a thermally conductive material. The thermally conductive material may be added to the composite to increase the thermal conductivity of the composite. The thermally conductive material may be present in an amount of 10%-30% by weight of the total composite weight. The thermally conductive material used may include chemicals selected from the group consisting of boron nitride, corundum, graphite and ceramic. In certain embodiments, the composite may include a combination of thermally conductive materials. Further, the thermally conductive material may be available in multiple forms, such as, but not limited to, amorphous, crystalline, graphene, nanoribbons, nanotubes, etc.

The composite may further include a flame retardant. The flame retardant may be added to the composite in order to prevent or slow down the development of fire caused due to thermal runaway of the cells. The flame retardant may be present in an amount of 0%-10% by weight of the total composite weight. Further, the flame retardant may be added to the composite to pass UL-94V-0 standard. For the purpose of explanation, UL-94 is the Standard for Tests for Flammability of Plastic Materials for Parts in Devices and Appliances. The composite may include flame retardants selected from the group consisting of hydrates based compounds, phosphorous based compounds, nitrogen based compounds, halogen based compounds, flame retardants or a combination thereof. More specifically, the flame retardant may include hydrates based compounds (magnesium hydroxide, stannic oxide, antimony trioxide, aluminium hydroxide, etc.), phosphorus based compounds (melamine, melamine cyanurate, melamine polyphosphate, etc.) nitrogen based compounds (triphenyl phosphate, ammonium polyphosphate, Poly (1,4-phenylenephenyl phosphate) (PPPO), poly (1,4 phenylenephenyl phosphonate) PPP etc.) or halogen based compounds (Hexabromocyclododecane (HBCD), tetrabromobisphenol A (TBBPA), tetrabromophthalic anyhydride, etc.). A person skilled in the art will appreciate that the one or more flame retardants may be added to the composite depending on the application where the composite may be implemented.

The composite may further include a polymer for enhancing the plasticity and reducing the brittleness of the composite. The polymer may be present in an amount of 0%-15% by weight of the total composite weight. In several embodiments, the composite may include a combination of different types of polymers. It will be apparent to a person skilled in the art that the different types of polymers may be combined to obtain desired properties in the composite. The polymer may be selected from the group consisting of Linear low-density polyethylene (LLDPE), (Low-density polyethylene) LDPE, (High-density polyethylene) HDPE, (Polypropylene) PP, (Ethylene propylene rubber) EPR, (Polyisobutene) PIB, (Ethylene propylene diene monomer) EPDM, (Ethylene-vinyl acetate) EVA, (styrene-ethylene-butylene-styrene) SEBS, Poly(styrene-butadiene-styrene) SBS, (Polycarbonates) PC, (Polyvinyl alcohol) PVA etc. The polymers may include one or both of an elastomer or a crystalline polymer. It will be apparent to a person skilled in the art that the elastomers may provide stiffness to the composite and the crystalline polymer may provide strength to the composite. In certain embodiments, the polymer may be grafted to provide better flame retardation properties or for holding the PCM efficiently.

In some embodiments, the composite may further include an anti-oxidant. The antioxidant may be added to the composite to maintain the Melt Flow Index (MFI) of the polymers used during processing. The anti-oxidant may be present in an amount of 0%-5% by weight of total composite weight. The anti-oxidants may include combination of processing and long term stability anti-oxidants that may be selected from the group consisting of hindered phenols, organic phosphites, and lactones. In certain embodiment, thiosynergists are also added to enhance the efficiency of antioxidants. It will be apparent to a person skilled in the art that the anti-oxidant may prevent degradation of polymers during blending.

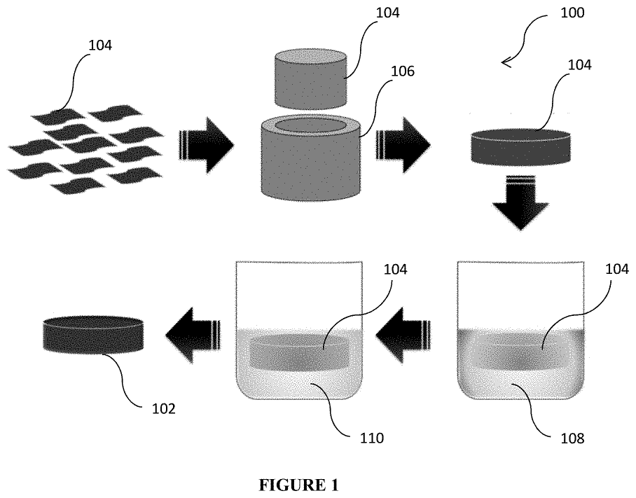

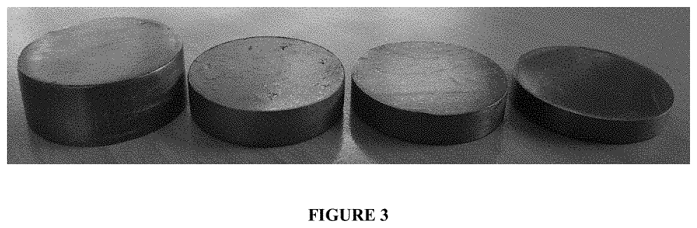

Referring now to FIG. 1, a schematic diagram of a method 100 of preparing a composite phase change material (hereinafter referred to as composite) 102 is disclosed, in accordance with another exemplary embodiment of the present invention. The method 100 of preparing the composite 102 may include a step of compressing a thermally conductive material 104. Before compressing the thermally conductive material 104, the thermally conductive material 104 may be first converted into a purified form. For doing so, the thermally conductive material 104 may be stirred in a chemical solution and then de-ionized with water to remove the impurities. In certain embodiments, fillers such as, but not limited to prepolymers or anti-oxidants or flame retardants may be added to the thermally conductive material 104 at this stage. Once the thermally conductive material 104 is converted into a purified form, it is dried and compressed into a desired shape having a predefined density. In a preferred embodiment, the thermally conductive material 104 may be compressed to achieve density in the range of 0.1 to 0.5 g/cc. FIG. 3 illustrates the compressed thermally conductive material with varied initial compression densities from 0.2 to 0.5 g/cc. A person skilled in the art will appreciate that the thermally conductive material 104 may be compressed into different shapes depending on the application. Further, the thermally conductive material 104 may be molded into different shapes via different shapes of molds 106. The thermally conductive material 104 may be selected from the group consisting of boron nitride, corundum and graphite. In a preferred embodiment, the thermally conductive material 104 may be graphite. For the purpose of explanation, the graphite may be in flake form having size in the range of 0.08 mm to 2 mm. Before compressing the graphite, the graphite may be converted into purified graphite via the above process. In certain embodiments, fillers may be added with the graphite to enhance the quality of the composite 102. The purified graphite flakes after adding the fillers may be transformed into purified graphite powder form.

The method 100 may further include a step of mixing or infiltrating the PCM 108 into the compressed thermally conductive material 104. For mixing or infiltrating the PCM 108 with the compressed thermally conductive material 104, the PCM 108 may be melted and converted into a molten state. A person skilled in the art will appreciate that the PCM 108 can be converted into molten state by any method known in the art. For example, the PCM 108 may be placed into a beaker and then heated in an oven for converting it into a molten state. It should be noted that the PCM 108 used herein may have a phase transformation temperature in the range of 30° C. to 60° C. The compressed thermally conductive material 104 is then dipped in the molten PCM 108 at elevated temperature under vacuum. In doing so, the compressed thermally conductive material 104 may absorb the PCM 108 into the matrix of the thermally conductive material 104 through capillary force. It should be noted that the percentage of PCM 108 absorption by the thermally conductive material 104 increases with the decrease in initial density of the compressed thermally conductive material 104. In certain embodiments, anti-oxidants or flame retardants may be added to the molten PCM 108 while dipping the thermally conductive material 104 in the PCM 108 to enhance the properties of the composite 102.

The method 100 may further include a step of coating the composite of PCM 108 absorbed thermally conductive material 104 with a flame retardant 110. The composite of PCM 108 absorbed thermally conductive material 104 may be coated with the flame retardant 110 by at least one of a dipping, brushing or spraying technique. Moreover, the composite of PCM 108 absorbed thermally conductive material 104 may be coated by the flame retardant slurry or resin. The flame retardant 110 may be either inorganic or organic in nature. In case of inorganic chemicals, the flame retardant 110 may be in the form of slurry. In case of organic, the flame retardant 110 may be in the form of resin. In one embodiment, the coating may be applied by dipping the composite of PCM 108 absorbed thermally conductive material 106 in the flame retardant slurry or resin. In another embodiment, the coating may be applied by brushing the flame retardant slurry or resin on the composite of composite of PCM 108 absorbed thermally conductive material 104. In yet another embodiment, the coating may be applied by spraying the flame retardant slurry or resin on the composite of PCM 108 absorbed thermally conductive material 104. The thickness of the coating applied on the composite of PCM 108 absorbed thermally conductive material 104 may vary in the range of 0.1 to 1 mm.

In certain embodiments, the composite of PCM 108 absorbed thermally conductive material 104 may be mixed with a polymer before coating with the flame retardant 110. In such embodiments, a polymer is added to composite of PCM 108 absorbed thermal conductive material 104 by blending or grinding the polymer. Further, in certain embodiments, the composite 102 may include anti-oxidants. The composite 102 prepared after the coating may include 10%-30% by weight of the thermally conductive material 104, 50%-80% by weight of the PCM 106, and 0%-10% by weight of the flame retardant 110.

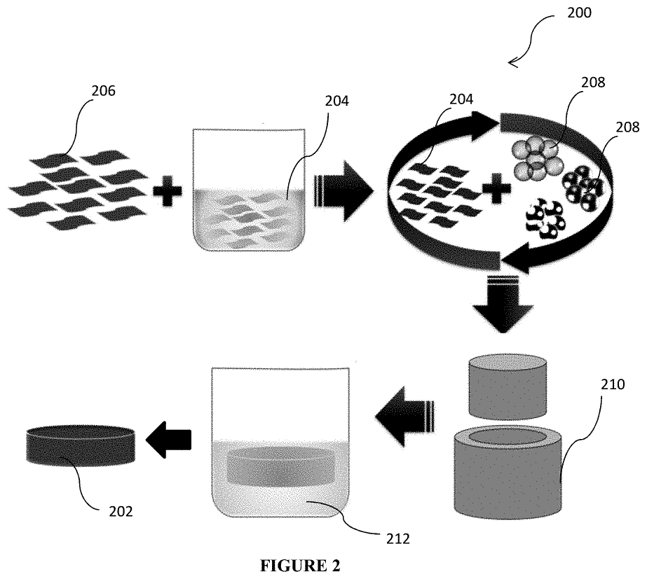

Referring now to FIG. 2, a method 200 of preparing a composite phase change material (hereinafter referred to as composite) 202 is disclosed, in accordance with another exemplary embodiment of the invention. The method 200 may include a step of mixing a PCM 204 with a purified thermally conductive material 206. In other words, the method includes a step of impregnating a purified thermally conductive material 206 with the PCM 204. In an embodiment, the purified thermally conductive material 206 may be mixed with the PCM 204 by dipping the purified thermally conductive material 206 in the molten PCM 204. For example, in case of thermally conductive material like graphite, the purified graphite may be dipped in a molten PCM. Moreover, in some embodiments, fillers such as polymer 208 or flame retardant 208 or anti-oxidant 208 may be added to the powdered mixture of the thermally conductive material 206 and the PCM 204.

The method 200 may further include a step of compressing the mixture of the thermally conductive material 206 and the PCM 204. The thermally conductive material 206 and the PCM 204 mixture may be compressed into desired shape in respective molds 210. Further, the thermally conductive material 206 and the PCM 204 mixture may be compressed to a predefined density. In a preferred embodiment, the mixture may be compressed to density in the range of 0.5 to 1 g/cc.

The method 200 may further include a step of coating the compressed mixture of the thermally conductive material 206 and the PCM 204 with a flame retardant 212. The compressed mixture may be coated with the flame retardant 212 by at least one of a dipping, brushing or spraying technique. Moreover, the compressed mixture may be coated by the flame retardant slurry or resin. In one embodiment, the coating may be applied by dipping the compressed mixture in the flame retardant slurry or resin. In another embodiment, the coating may be applied by brushing the flame retardant slurry or resin on the compressed mixture. In yet another embodiment, the coating may be applied by spraying the flame retardant slurry or resin on the compressed mixture of the thermally conductive material 206 and the PCM 204. The composite 202 prepared after the coating may include 10%-30% by weight of the thermally conductive material 206, 50%-80% by weight of the PCM 204, and 0%-10% by weight of the flame retardant 212.

The present invention is described in further detail in connection with the following examples which illustrate or stimulate various aspects involved in the practice of the invention. It is to be understood that all changes that come within the spirit of the invention are desired to be protected and thus the invention is not to be construed as limited by these examples.

### EXAMPLES

### Example 1:

Composition:
1) PCM with melting point 42° C.; weight %: 75
2) Chemical treated, heat treated and purified thermally conductive material; weight %: 20
3) Flame retardant coating; weight %: 5

Method of Preparation:

4 grams of purified thermally conductive material such as graphite with initial density of ˜0.02 g/cc is added to a cylindrical mold with 4 cm diameter and 30 cm height. The sample is then compressed with hydraulic compression machine till it forms 0.2 g/cc disc. Simultaneously, 15 grams of PCM having melting point of 42° C. is kept in 50 ml beaker and melted in oven at 70° C. The thermally conductive material disc is dropped in molten PCM and kept for 18 to 24 hours to completely absorb the PCM through capillary force or under vacuum. Finally, the samples are cooled down and dipped in solution containing flame retardant, thermal conducting agent and anti-oxidants for 5 to 10 minutes. The coating is then allowed to cure for few hours at 60° C.

### Example 2:

Composition
1) PCM with melting point 48° C.; weight %: 75
2) Chemical treated, heat treated and purified thermally conductive material; weight %: 20
3) Flame retardant coating; weight %: 5

Method of Preparation:

4 grams of purified thermally conductive material such as graphite with initial density of ˜0.02 g/cc is added to a cylindrical mold with 4 cm diameter and 30 cm height. The samples are then compressed with hydraulic compression machine till it forms 0.2 g/cc disc. Simultaneously, 15 grams of PCM having melting point of 48° C. is kept in 50 ml beaker and melted in oven at 70° C. The thermally conductive material disc is dropped in molten PCM and kept for 18 to 24 hours to completely absorb the PCM through capillary force or under vacuum. Finally, the samples are cooled down and dipped in solution containing flame retardant, thermal conducting agent and anti-oxidants for 5 to 10 minutes. The coating is then allowed to cure for few hours at 60° C.

### Example 3:

Composition:
1) PCM with melting point 42° C. or 48° C.; weight %: 60
2) Chemical treated, heat treated and purified thermally conductive material; weight %: 30
3) Flame retardant coating; weight %: 10

Method of Preparation:

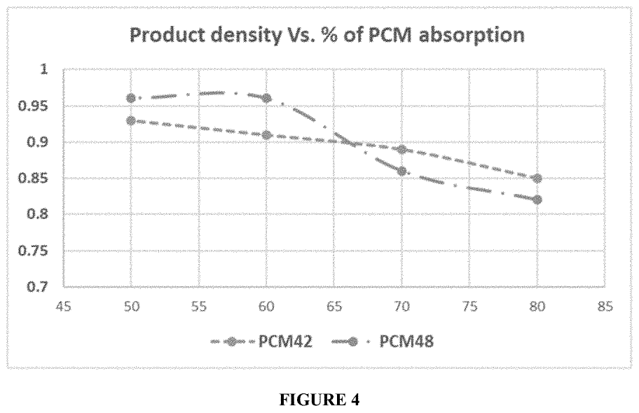

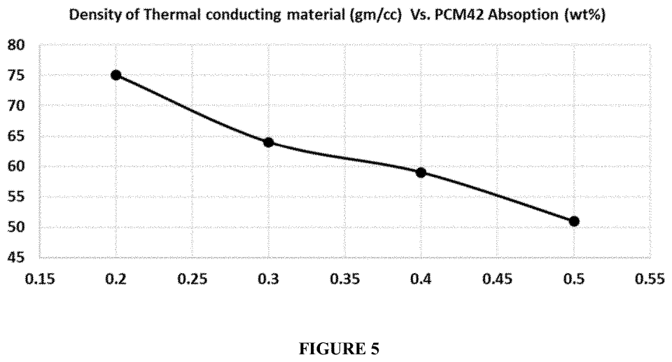

4 grams of purified thermally conductive material such as graphite with initial density of ˜0.02 g/cc is added to a cylindrical mold with 4 cm diameter and 30 cm height. The samples are then compressed with hydraulic compression machine till it forms 0.5 g/cc disc. The thermally conductive material discs are dropped in molten PCMs having melting point of 42° C. or 48° C. and kept for 18 to 24 hours to completely absorb the PCM through capillary force or under vacuum. Finally, the samples are cooled down and dipped in solution containing flame retardant, thermal conducting agent and anti-oxidants for 5 to 10 minutes. The coating is then allowed to cure for few hours at 60° C. The variation in PCM absorption percentage with respect to final product density is represented in FIG. 4. The final composite is then processed for calculating the densities, and further analysis is carried out for determining thermal conductivity and latent heat. Similarly, by altering initial densities of purified graphite powder and absorption % of PCM, the thermal conductivity and latent heat can be varied depending on the application requirement. Thermal conductivity and latent heat of the sample with 0.2 to 0.5 g/cc compressed graphite disc and 50-80 weight % absorption of PCM having melting point of 42° C. showed in the range of 10-25 W/mK and 130-170 J/g, respectively. This variation is shown in FIG. 5

### Example 4:

Composition:
1) PCM with melting point 48° C.; weight %: 75.
2) Chemical treated, heat treated and purified thermally conductive material; weight %: 20.
3) Flame retardant coating; weight %: 5.

Method of Preparation:

4 grams of purified thermally conductive material such as graphite with initial density of ˜0.02 g/cc is added to a cylindrical mold with 4 cm diameter and 30 cm height. The samples are then compressed with hydraulic compression machine till it forms 0.2 g/cc disc. Simultaneously, 15 grams of PCM having melting point of 48° C. is kept in 50 ml beaker and melted in oven at 70° C. The thermally conductive material disc is dropped in molten PCM and kept for 18 to 24 hours to completely absorb the PCM through capillary force or under vacuum. Finally, the samples are cooled down and a solution containing flame retardant, thermal conducting agent and anti-oxidants is sprayed to form uniform film on the composite surface. The coating is then allowed to cure for few hours at 60° C.

### Example 5:

Composition:
1) PCM with melting point 48° C.; weight %: 60
2) Chemical treated, heat treated and purified thermally conductive material; weight %: 30
3) Flame retardant coating; weight %: 10

Method of Preparation:

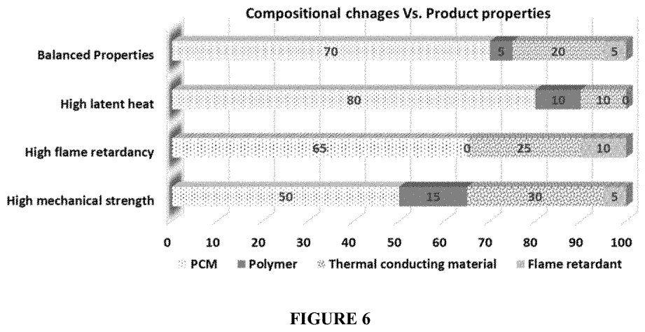

4 grams of purified thermally conductive material such as graphite with initial density of ˜0.02 g/cc is added to a cylindrical mold with 4 cm diameter and 30 cm height. The samples are then compressed with a hydraulic compression machine till it forms 0.2 g/cc disc. Simultaneously, different weight ratios of PCM having melting point of 48° C. are kept in 50 ml beaker and melted in oven at 70° C. The thermally conductive material discs are dropped in molten PCM for absorption through capillary force or under vacuum. The samples are taken out between 12 hours to limit the absorption percentage depending on the latent heat requirement. Finally, the samples are cooled down and dipped in solution containing flame retardant, thermal conducting agent and anti-oxidants for 5 to 10 minutes. The coating is then allowed to cure for few hours at 60° C. Variation in composition of thermally conductive material, PCM, polymer and flame retardant is carried out to alter the final properties required in the composite as shown in FIG. 6.

### Example 6:

Method of Preparation by Method 200:

Alternatively, 4 grams of thermally conductive material such as purified graphite with initial density of ˜0.02 g/cc is added in the molten PCM for absorption through capillary force or under vacuum for approximately 1 to 2 hours and also stirred at regular intervals for uniform absorption of PCM. The as received powder is added to the polymer or flame retardant or anti-oxidant as binder and blended for 20 to 45 minutes for form uniform powder. This is further added in to a cylindrical mold with 4 cm diameter and 30 cm height. The samples are then compressed with hydraulic compression machine with or without heat supply till it forms 0.8 to 0.99 g/cc disc. Finally, the samples are dipped in solution containing flame retardant, thermal conducting agent and anti-oxidants for 5 to 10 minutes. The coating is then allowed to cure for few hours at 60° C.

### Example 7

The polymer, rubber and polyethylene, are co-extruded to form a prepolymer. 15 g of prepolymer is then mixed with 60 g of PCM, 10 g of purified graphite, 7.5 g flame retardant and 7.5 g antioxidant, under high temperature and shear. The blend thus formed reflects the properties of a rubber. The flexibility in the blend makes it injection moldable. The final composite, obtained by injection molding can be coated with a suitable coating material which enhances flame retardant properties.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and appended claims.

What is claimed is:

1. A composite phase change material comprising:
a phase change material present in an amount of 50%-80% by weight;
a thermally conductive material present in an amount of 10%-30% by weight;
a flame retardant present in an amount of 0%-10% by weight;
a polymer present in an amount of 0%-15% by weight; and
an anti-oxidant present in an amount of 0%-5% by weight.

2. The composite phase change material as claimed in claim 1, wherein the phase change material has a phase change temperature in the range of 30° C. to 60° C.

3. The composite phase change material as claimed in claim 1, wherein the phase change material is selected from the group consisting of fatty acids, fatty acid esters, paraffin and blends of organic materials.

4. The composite phase change material as claimed in claim 1, wherein the thermally conductive material includes a primary thermally conductive material and a secondary thermally conductive material.

5. The composite phase change material as claimed in claim 4, wherein the primary thermally conductive material is present in an amount of 60%-100% by weight of the thermally conductive material, and the secondary thermally conductive material is present in an amount of 0%-40% by weight of the thermally conductive material.

6. The composite phase change material as claimed in claim 4, wherein the primary thermally conductive material is selected from the group consisting of intercalated graphite, expanded graphite, purified expanded graphite, graphene, surface functionalized graphene, graphene fibers, graphene nanosheets and mixture thereof.

7. The composite phase change material as claimed in claim 4, wherein the secondary thermally conductive material is selected from the group consisting of intercalated graphite, expanded graphite, purified expanded graphite, graphene, surface functionalized graphene, single and multiwall carbon nanotubes, graphene quantum dots, graphene fibers, boron nitride, corundum, ceramic or a combination thereof.

8. The composite phase change material as claimed in claim 1, wherein the flame retardant is selected from the group consisting of hydrate based compounds, phosphorus based compounds, nitrogen based compounds, halogen based compounds, flame retardant polymers, resin or a combination thereof.

9. The composite phase change material as claimed in claim 1, wherein the polymer is selected from the group consisting of Linear low-density polyethylene (LLDPE), Low-density polyethylene (LDPE), High-density polyethylene (HDPE), Polypropylene (PP), Ethylene propylene rubber (EPR), Polyisobutene (PIB), Ethylene propylene diene monomer (EPDM), Ethylene-vinyl acetate (EVA), styrene-ethylene-butylene-styrene (SEBS), Poly(styrene-butadiene-styrene) (SBS), Polycarbonates (PC) and Polyvinyl alcohol (PVA) or a combination thereof.

10. The composite phase change material as claimed in claim 1, wherein the anti-oxidant includes combination of processing and long term stability anti-oxidants that may be selected from the group consisting of hindered phenols, organic phosphites, and lactones.

11. The composite phase change material as claimed in claim 1, wherein the composite phase change material is configured to cool the lithium ion cells.

12. The composite phase change material as claimed in claim 1, wherein the composite phase change material is provided in a solar photo voltaic system to cool the solar photovoltaic panels.

13. A method for preparing a composite phase change material, the method comprising:
compressing a thermally conductive material to a predefined density;
mixing or absorbing or infiltrating a phase change material into the compressed thermally conductive material; and
coating the composite of phase change material absorbed thermally conductive material with a flame retardant slurry or resin.

14. The method as claimed in claim 13, wherein the composite phase change material comprises 10%-30% by weight of the thermally conductive material, 50%-80% by weight of the phase change material, 0%-10% by weight of the flame retardant, and 0%-5% by weight of an anti-oxidant.

15. The method as claimed in claim 13, wherein mixing or absorbing or infiltrating the phase change material into the thermally conductive material is done via processes including pressure induced absorption, impregnation and vacuum impregnation and combinations thereof.

16. The method as claimed in claim 13, wherein the method further comprises a step of blending or grinding a polymer along with the composite of phase change material absorbed thermally conductive material.

17. The method as claimed in claim 13, wherein the compressed thermally conductive material is mixed with the phase change material by dipping the thermally conductive material in the molten phase change material under vacuum or through capillary force.

18. The method as claimed in claim 13, wherein the composite of phase change material absorbed thermally conductive material is coated with the flame retardants by dipping the composite of phase change material absorbed thermally conductive material in the flame retardant slurry or resin.

19. The method as claimed in claim 13, wherein the composite of phase change material absorbed thermally conductive material is coated with the flame retardants by spraying the flame retardant slurry or resin on the composite of phase changed material absorbed thermally conductive material.

20. The method as claimed in claim 13, wherein the composite of phase change material absorbed thermally conductive material is coated with the flame retardants by brushing the flame retardant slurry or resin on the composite of phase change material absorbed thermally conductive material.

21. A method for preparing a composite phase change material, the method comprising:
mixing or absorbing or infiltrating a phase change material with a thermally conductive material;
compressing the mixture of the thermally conductive material and the phase change material; and
coating the compressed mixture of the thermally conductive material and the phase change material with a flame retardant slurry or resin.

22. The method as claimed in claim 20, wherein the composite phase change material comprises 10%-30% by weight of the thermally conductive material, 50%-80% by weight of the phase change material, 0%-10% by weight of the flame retardant, and 0%-5% by weight of an anti-oxidant.

23. The method as claimed in claim 21, wherein mixing or absorbing or infiltrating the phase change material with the thermally conductive material is done with processes including pressure induced absorption, impregnation and vacuum impregnation and combinations thereof.

24. The method as claimed in claim 21, wherein the method further comprises a step of blending or grinding a polymer along with the phase change material and the thermally conductive material.

25. The method as claimed in claim 21, wherein the compressed mixture of thermally conductive material and phase change material is coated with the flame retardants by dipping the compressed mixture in the flame retardant slurry or resin.

26. The method as claimed in claim 21, wherein the compressed mixture of thermally conductive material and phase change material is coated with the flame retardants by spraying the flame retardant slurry or resin on the compressed mixture.

27. The method as claimed in claim 21, wherein the compressed mixture of thermally conductive material and phase change material is coated with the flame retardants by brushing the flame retardant slurry or resin on the compressed mixture.
